(19) United States
(12) Patent Application Publication
(10) Pub. No.: US 2026/0055658 A1
(43) Pub. Date: Feb. 26, 2026

(54) CEILING ACCESS DOORS WITH HINGES AND AN INSULATION DAM

(71) Applicant: A.J. Manufacturing, Inc., Bloomer, WI (US)

(72) Inventors: Todd Carlson, Chippewa Falls, WI (US); Brian A. Jensen, Rice Lake, WI (US); Gregory Miller, Eau Claire, WI (US)

(21) Appl. No.: 18/815,050

(22) Filed: Aug. 26, 2024

(51) Int. Cl. E06B 7/28; E05D 1/06; E05D 7/00; E06B 1/02; E06B 3/38; E06B 3/48; E06B 3/70

(52) U.S. Cl. CPC E06B 7/28; E05D 1/06; E05D 7/009; E06B 3/38; E06B 3/483; E06B 3/7015; E05Y 2900/132; E06B 1/02; E06B 2003/7023

(57) ABSTRACT

Insulated ceiling access doors have a two-part tongue and slot hinge. The doors are made of two interlock pans that are filled with injected polyurethane foam. The doors vary in length, width and thickness. The doors are mounted in ceiling access door frames. Four-part side and end walls insulation dams are permanently mounted above the door frames for holding back insulation from falling downward within the attic area. The doors have hold-open hardware.

### BACKGROUND OF THE INVENTION

Commercial, industrial and residential buildings often have drop-down ceilings with insulation sprayed on top of the ceiling in the attic space thereabove. Sometimes flooring is installed above the insulation for storage reasons. Batted fiberglass rolls are also used, rolled out on top of the ceiling in the attic space. Flooring may also be added on top of the insulation.

Ceiling access openings are needed to gain access into the attics to complete the insulating steps, to add flooring and to provide for storage for, and access to, items currently not in use therebelow. Ceiling access openings need to be closed when access into the attic space is not needed. It is also desirable that ceiling access doors be insulated to keep undesirable extreme cold, heat and drafts out of the spaces below the ceilings. A batt of fiberglass insulation is commonly laid on top of the door when closing the door. Common ceiling access openings may very greatly but 24-inch×36-inch or 24-inch×48-inch openings are quite common.

Ceiling access doors have been known to be heavy, clumsy, dangerous and difficult to open, hold in open position, or be moved into a storage position. Commonly, ceiling access doors are lifted straight upwardly with a person's hands therebelow standing on a ladder. The doors must be lifted high enough through the opening as to clear the insulation and flooring surrounding the opening and set aside once out of the door opening so that the person can gain access into the attic space. There is always a chance that the door might accidently be dropped and hit the person directly below or another person adjacent and holding the ladder.

Some ceiling access doors are hinged to the framing just above the ceiling opening so that the doors may be swung open pivoting on the hinges passed center of the hinges and somehow held in place or propped up to an open position. This works well with internally insulated doors that are less than two inches thick. Doors that are greater than 2 inches thick, such as four-inch or six-inch thicknesses have a geometry problem. The thicker the door, the greater diagonal dimension from the top hinged edge to the opposite lower edge which creates a place of interference which will strike the door frame. Consequentially, these thicker doors require a tapered edge or frame to create ‘a tapered cork in the bottle’ to clear the frame.

Insulation around the door opening can also cause problems. As the door is opened, the door tends to scrape on the insulation as it is lifted upwardly. Further, many types of insulation are loose fibers or cellulose that simply fall downwardly out of the door opening, getting into a person's eyes and creating a dirty mess below the opening and requiring clean up each time the attic is accessed. Another problem is that if there is just a single person opening the door and accessing the attic space and the door is not properly blocked open, the door may fall closed to the door frame trapping the person in the attic as ceiling access doors do not open downwardly into the space below.

There is a need for ceiling access doors with hinges and insulation dams that addresses these above problems and provides additional advantages.

### SUMMARY OF THE INVENTION

Insulated ceiling access doors have a two-part tongue and slot hinges. The doors are made of two interlocking pans that are filled with injected polyurethane foam. The doors vary in length, width and thicknesses. The doors are mounted in ceiling access door frames that have hold-open hardware. Four-part side and end walls insulation dams are permanently mounted above the door frames for holding back insulation from falling downward within the attic area.

A principal object and advantage of the present invention is that the two-part tongue and slot hinges are made from 16-gauge galvanized steel allow for play in the hinge to assist in opening and closing of the ceiling access doors that resist rust, are rigid, insulated, durable and of no interest to pests.

Another object and advantage of the two-part tongue and slot hinges are functionally interlockable together so that the ceiling door cannot fall through the ceiling access door opening causing injury, damage or necessary insulation cleanup.

Another object and advantage of the two-part tongue and slot hinges is that they are shipped flat and are preprocessed with a turret punch forming the shapes, holes, slots, tabs, and perforations for easy folding into hinges components.

Another object and advantage of the ceiling access doors is that they are made of 24-gauge galvanized steel, generally 24 inches×36 inches or 24 inches×48 inches with thicknesses of 1 inch, greater than 2 inches, 4 inches (R28) or 6 inches (R42). The single panel door is a two lipped, rim walled ceiling panel and a metal panel. The panels are adhesively secured by being filled with expanding polyurethane foam rendering the door extremely strong.

Another object and advantage of the ceiling access doors is that they may be split into two parts and joined with a piano hinge with an adjacent air flow preventing the self-adhesive gasket to limit air leakage. The door is mounted with two tongue and slot hinges. To open the door, the door is pushed up in the area opposite of the hinges and then pushed up adjacent the piano hinge to fold the door upwardly and pushing the door toward the hinges until both panels are touching and will rest on the door frame or the ceiling access wood frame.

Another object and advantage of the present invention is that the insulation dam is shipped flat and is preprocessed with a turret punch forming the shapes, holes, slots, tabs, perforations for easy folding into two ends and two side walls comprising the insulation dam, universal for all doors contemplated here.

Another object and advantage of the present invention is that the insulation dam is made of 24-gauge galvanized steel that resists rust, is rigid, durable and of no interest to pests. The dam may be assembled in the attic area with connections of corresponding tabs and slots and simply lowered down onto the ceiling access door frame and screwed in place into the door wood frame.

Another object and advantage of the present invention is that the insulation dam can be installed with a 1-inch side edge hinge ceiling access door (R7; 24 inches×36 inches and 24 inches×48 inches); a greater than 2-inch side end edge hinge ceiling access door (R7; 24 inches×36 inches and 24 inches×48 inches); a 4-inch door end edge hinge, single piece or bifold (R28; 24 inches×36 inches and 24 inches×48 inches); or a 6-inch end edge hinge door, single piece or bifold (R42; 24 inches×36 inches and 24 inches×48 inches).

Another object and advantage of the present invention is that the insulation dam can be made of ‘second quality” steel for a much lower cost than prime steel, and when installed, it is rarely ever visible and flaws of this type have no functional impact or problems installing.

Another object and advantage of the present invention is that the insulation dam has one top outwardly folded tightly flat edge (hem) made with a folding machine for greater strength and to provide a safe place to grab with bare hands.

Another object and advantage of the present invention is that the insulation dam holds back blown cellulous or fiberglass insulation from fall through the door opening.

Another object and advantage of the present invention is that the insulation dam can be used with a door hold-open key held in storage or door open position by insertion into precut slots.

### BRIEF DESCRIPTION OF THE DRAWINGS

FIG. 1 is a top perspective view of the mounting plate and tongue portion of the two-part tongue and slot hinge in flat shipping condition;

FIG. 2 is a top plan view of the tongue portion of the two-part tongue and slot hinge in flat shipping condition;

FIG. 3 is a top perspective view of the tongue portion and the tongue slot and tongue mounting plate there below of the two-part tongue and slot hinge in in assembly ready position;

FIG. 4 is a top perspective view of the tongue portion and the tongue slot and mounting plate of the two-part tongue and slot hinge in locked assembled condition;

FIG. 5 is a bottom perspective view of the tongue portion and the tongue slot of the two-part tongue and slot hinge with the tongue in locked assembled condition;

FIG. 6 is a top perspective view of the of the ceiling access door wood framing in the ceiling with the tongue slot and mounting plate in operable position and the ceiling access door frame in operable condition;

FIG. 7 is a bottom plan view of the assembled and locked two-part tongue and slot hinge;

FIG. 8 is a top perspective view partially broken away of the of the ceiling access door mounted in operable closed position;

FIG. 9 is a side top perspective view of the ceiling access door mounted in operable closed position;

FIG. 10 is a top perspective view of the of the ceiling access door mounted in partially open position and full open position in phantom outline;

FIG. 11 is a side elevational view of the ceiling door in closed position for explanation of the geometric interference between the door's bottom front edge and the door wood framing;

FIG. 12 is a side top perspective view of the bifold ceiling access door mounted in operable closed position;

FIG. 13 is a side top perspective view of the bifold ceiling access door mounted in operable partially open position;

FIG. 14 is a side top perspective view of the bifold ceiling access door mounted in operable partially open phantom position and fully opened position;

FIG. 15 is a top perspective view partially broken away of the bifold ceiling access door partially open exposing its piano hinge and gasket;

FIG. 16 is a cross sectional view taken along lines 16-16 of FIG. 6 partially broken away;

FIG. 17 is a top perspective view of the disassembled insulation dam and door hold open key is in shipping flat position;

FIG. 18 is a top perspective view of the disassembled insulation dam with the beginning of folding over of panels along the folding perforations;

FIG. 19 is a top perspective view of the disassembled insulation dam with further folding over of panels along the folding perforations;

FIG. 20A is a broken away perspective view of the door hold open key mounted in key mount slots;

FIG. 20 is a perspective view of the door hold open key with folded over of panels along the folding perforations;

FIG. 21A is a perspective view of the door hold open key rest in slots;

FIG. 21 is a top perspective view of the partially assembled insulation dam with tabs and slots starting to be connected;

FIG. 22 is a top perspective view of the disassembled insulation dam with further tabs and slots being connected;

FIG. 23 is a top perspective view of the disassembled insulation dam with still further tabs and slots being connected;

FIG. 24 is a top perspective view of the assembled insulation dam;

FIG. 25 is a top perspective view of the assembled insulation dam installed on top of the ceiling access door frame and secured to the wood door frame with screws;

FIG. 26 is a cross sectional partially broken away view taken along lines 26-26 of FIG. 25 of the assembled insulation dam installed on top of the ceiling access door frame and secured to the wood door frame with screws;

FIG. 27 is a top perspective view of the assembled insulation dam installed on top of the ceiling access door frame and secured to the wood door frame with screws with the closed 1 inch ceiling access door installed and partially open in phantom and the hold open key in a storage position; and

FIG. 28 is a top perspective view of the assembled insulation dam installed on top of the ceiling access door frame and secured to the wood door frame with screws with the opened ceiling access door held open by the hold open key.

### DETAILED DESCRIPTION

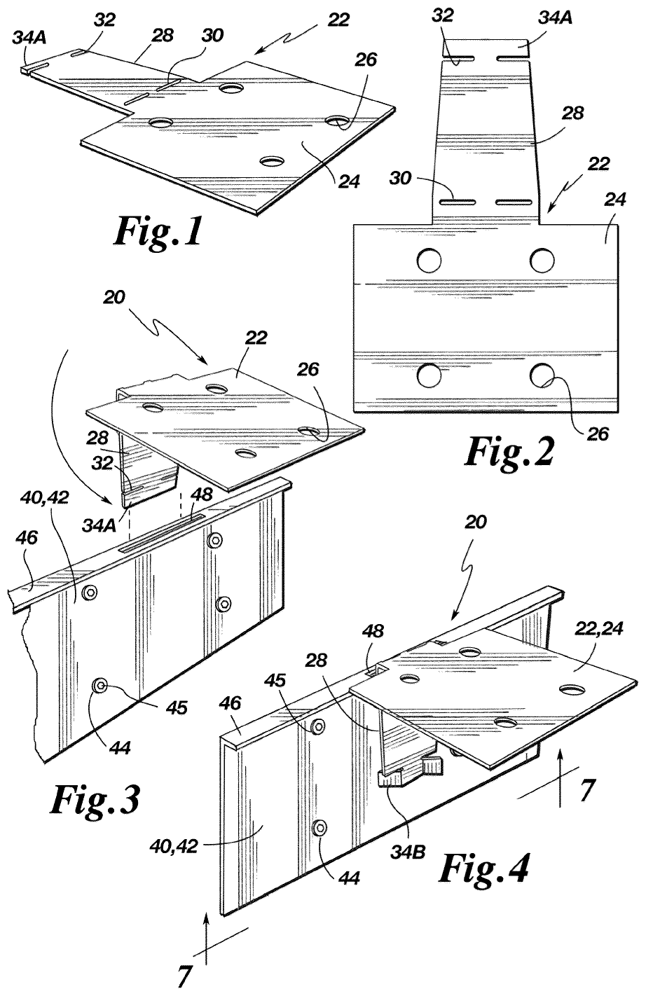

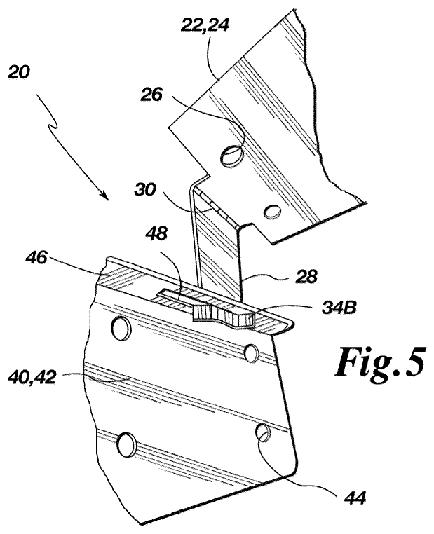

Referring to FIGS. 1 through 7, the two-part tongue and slot hinge 20 may be understood. The hinge is generally flat during storage and shipping. When the hinge is ready to be used, the flat tongue portion 28 and mounting plate or panel 22 with holes 26 and screws 27 may be gripped and be bent 90° along the slots, serrations, scoring or reliefs 30. The tongue and mounting plate 22 may be secured to the bottom end or lower edge 104 of a ceiling access door 80, 88, 89, 90 or 91. The doors are described further below. The tongue portion also has two lower slots 32 which create locking tabs 34A and 34B.

The tongue slot and mounting plate 40 has a screw mounting plate or panel 40 with holes 44 and screws 45 mounted to the interior attic wood door frame 58. The tongue slot and mounting plate 40 has a short upper wall 46 with a slot 48. The ceiling access door frame 58 has a lower door frame 60 with trim 62, jam 66, door rest or stop 68 and thermal and draft insulation stripping 70. All secured to the wood door frame 58 with screws 64.

When ready for installation and the hinge 20 is properly secured to the door and the door frame 58, the door is initially lifted up through the door opening 50. Then the door is lower into the lower door frame 60 as tongue 28 is guided into tongue slot 48. The final step is to bend the locking tabs 34a and 34B as to prevent door 80, 81, 88, 89, 90 or 91 from separating from the tongue slot and mounting plated 40 so as to not fall through the ceiling door opening 50 and cause injury or damage there below.

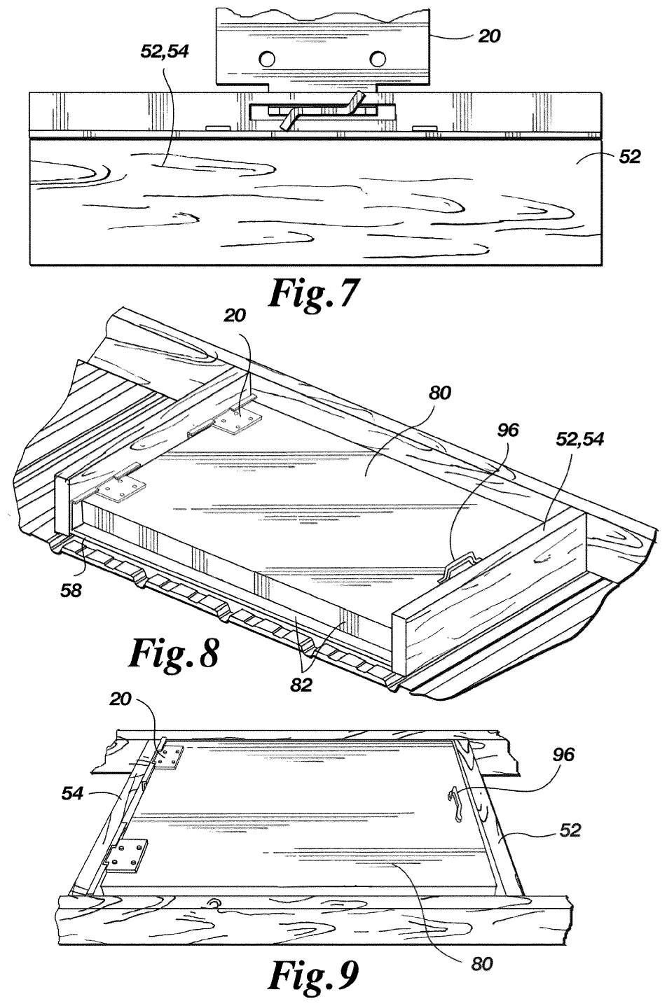

Referring to FIGS. 7 through 10, the one piece ceiling access doors 80, 81, 88 and 90 may be understood. The doors are made of G90 galvanized steel that is 24 gauge. The doors may be a 1-inch side hinge ceiling access door 80 (R7; 24 inches×36 inches and 24 inches×48 inches); a greater than 2-inch side hinge ceiling access door 81 (R7; 24 inches×36 inches and 24 inches×48 inches); a 4-inch door, single piece 88 or bifold 89 (R28; 24 inches×36 inches and 24 inches×48 inches); or, a 6-inch door, single piece 90 or bifold 91 (R42; 24 inches×36 inches and 24 inches×48 inches). The one piece doors 80, 81, 88 and 90 are simply opened over center of the hinges and rest there at in open position. Handle 96 is provided for lifting and lowering the doors from the attic.

The doors may be manufactured by interlocking pans 82 that are adhesively secured together. The doors are then placed in a press that is typically heated although not necessary. The polyurethane foam, that is injected into the doors’ void, is a mixed two part chemical injected by a nozzle. Great force is created by the foam as the two chemicals react and are forced to expand in an exothermic reaction. Once the injection is complete, the foam seals the upper and lower pans 82 together forming the doors.

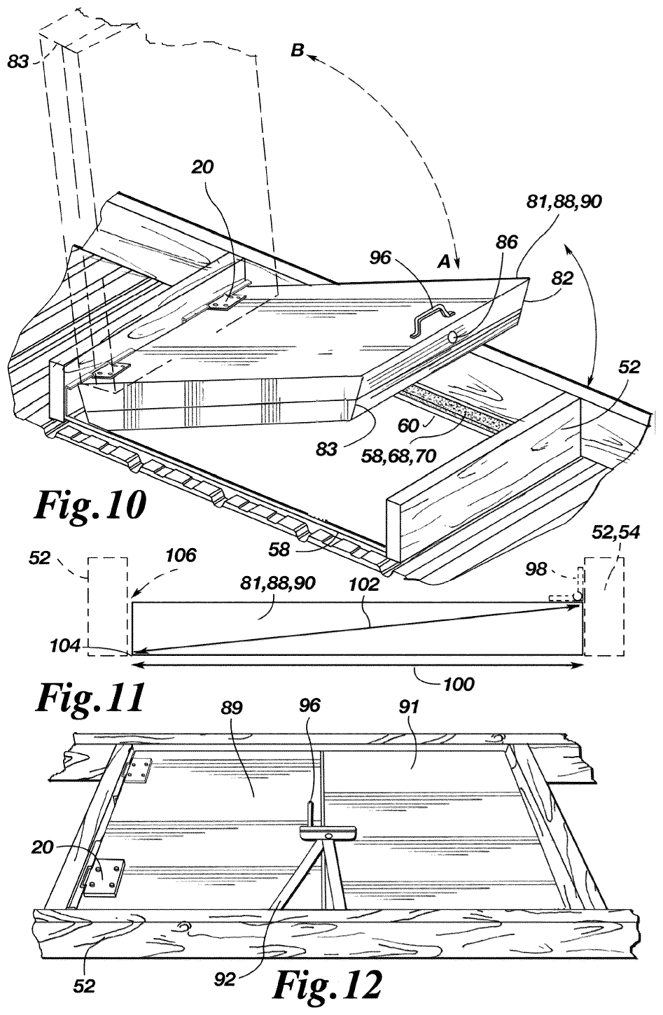

Referring to FIGS. 10 and 11, one piece doors 81, 88 and 90 that are greater than 2 inches thick, such as four-inch or six-inch thickness have a geometry problem. The thicker the door, the greater diagonal dimension 102 from the top hinged edge 98 to the opposite lower edge 104 which creates a place of interference 106 which will strike the wood door frame 52, 54. Consequentially, these thicker doors require a tapered edge 83 to create a tapered “cork in the bottle” to clear the frame 52, 54 at 106 when opening (arrow heads A to B).

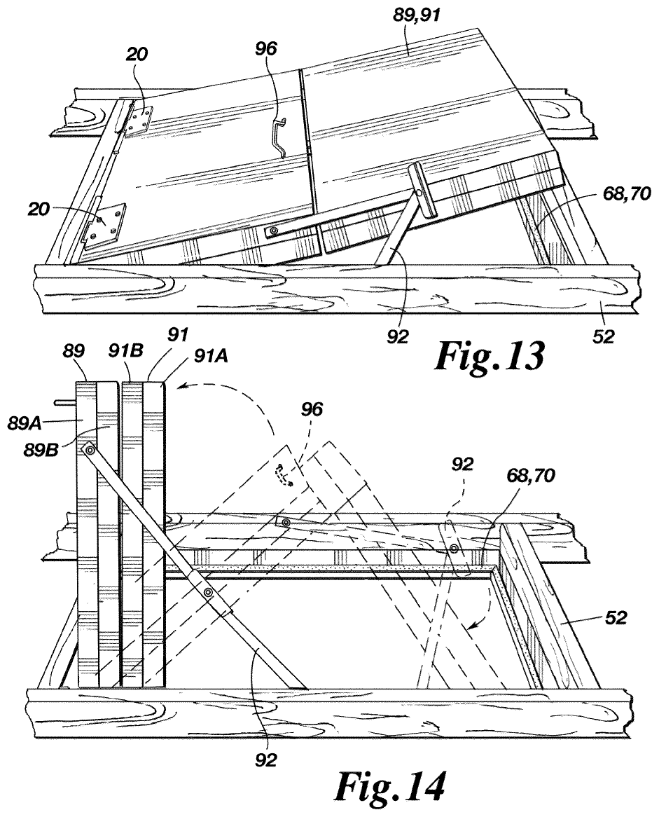

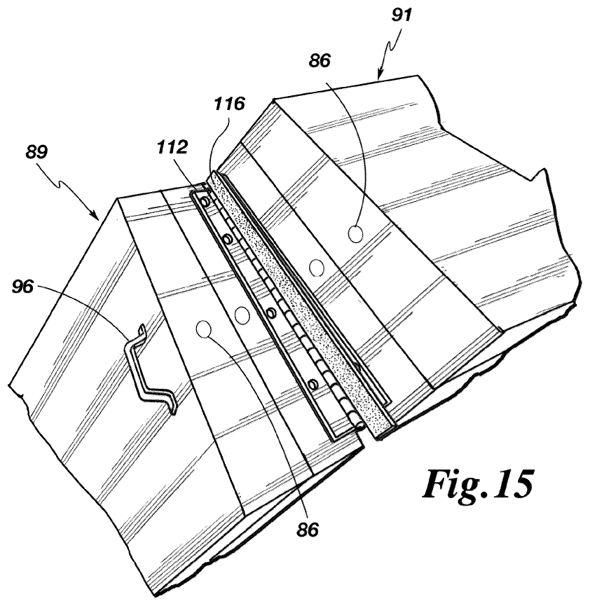

Referring to FIGS. 11 through 15, bifold access doors 89, 91 (hinged door panels) of 36 or 48 inches may be understood as a convenient way to solve the above geometric problem of door interference with the wood door frame 52 without sacrificing insulated door thickness and provide easy open and closing of the hinged doors. Doors 89, 91 have a top side stabilizing, guiding and hold open strut 92. Once the strut 92 passes over 180° the strut locks in place and will hold open the bifold doors 89, 91 (FIG. 14). A handle 96 provides assistance in opening and closing all doors from the attic space.

The bifold doors 89, 91 are also made of interlocking pans 89A, 89B, 91A and 91B that are foam filled. The door panels 89, 91 are joined lowermost at the bottom edge of opposing end walls by a piano hinge 112. Thermal and draft insulation stripping 116 is adhered to one leaf side of the hinge 112.

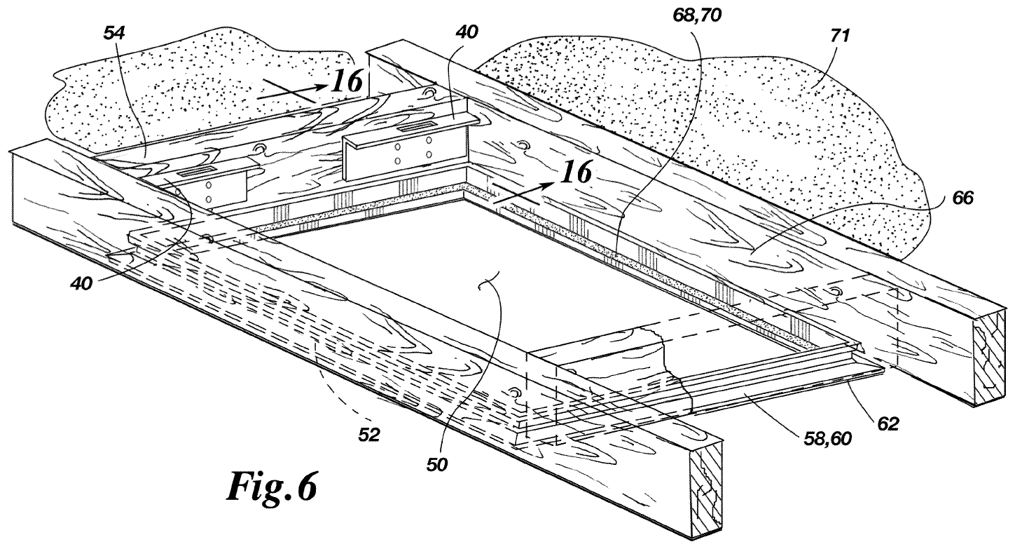

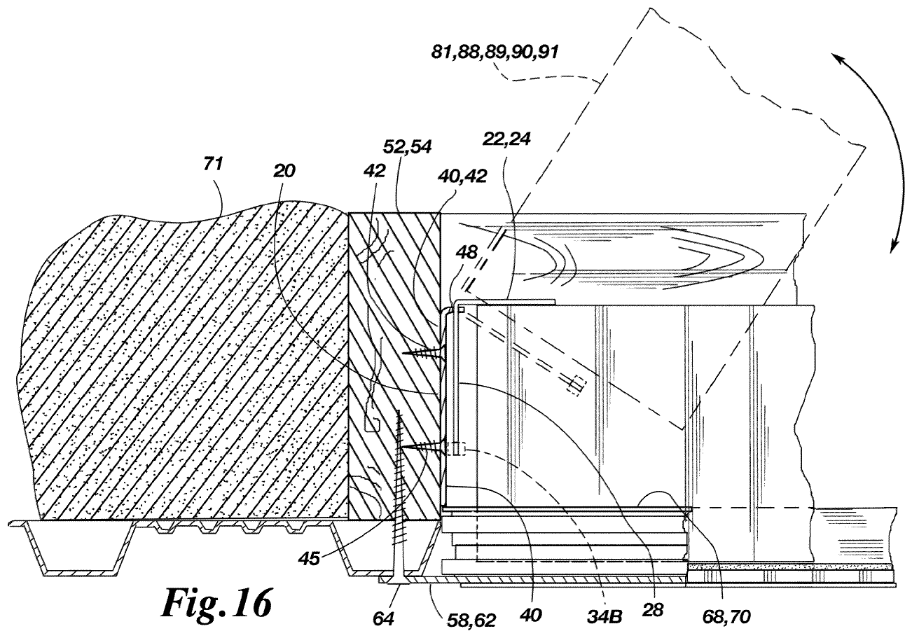

Referring to FIG. 16, a cross sectional view from FIG. 6 will illustrate detail as to how the doors and framing are mounted together. First the door wood framing 52 is created. Next the two-part tongue and slot hinge 20 are installed at the framing 52 and door 80, 81, 88, 89, 90 or 91. Following next, the lower door framing 58, 60, 62 is installed from below with screws 64. The frame 60 includes trim 62, jamb 66, door stop 68 with thermal and draft insulation stripping 70. Outside of the wood framing can be seen insulation 71. The door is next lowered into the ceiling access wood door frame 58 to engage the hinge tongue 28 into the hinge slot 48. Then from below the locking tabs 34A, 34B are bent with a pliers to form a locking engagement so that the tongue 28 cannot come out of the slot 48. By this arrangement, there is substantial play in the hinge 20 to assist the door in opening and closing.

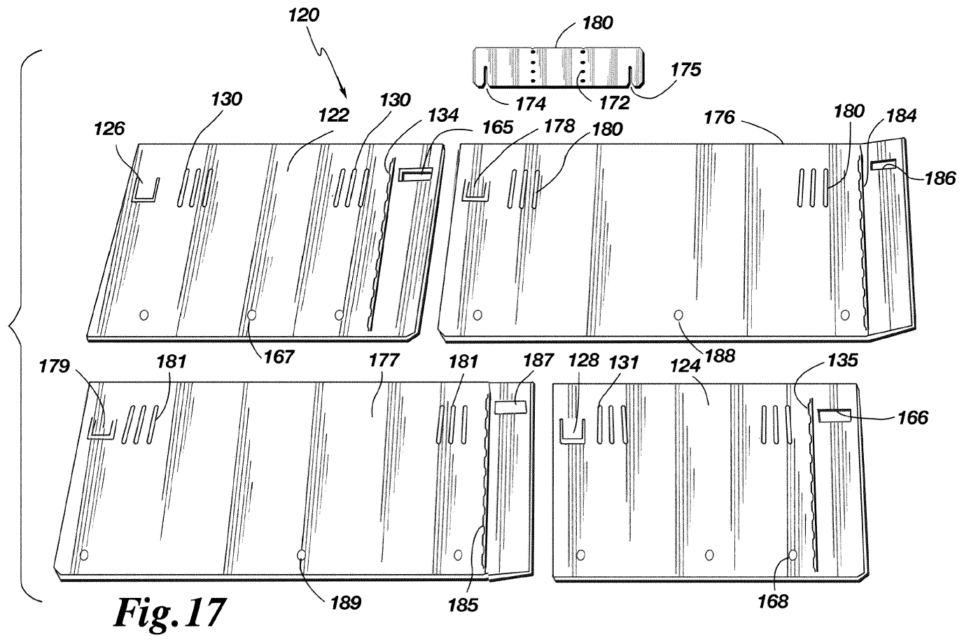

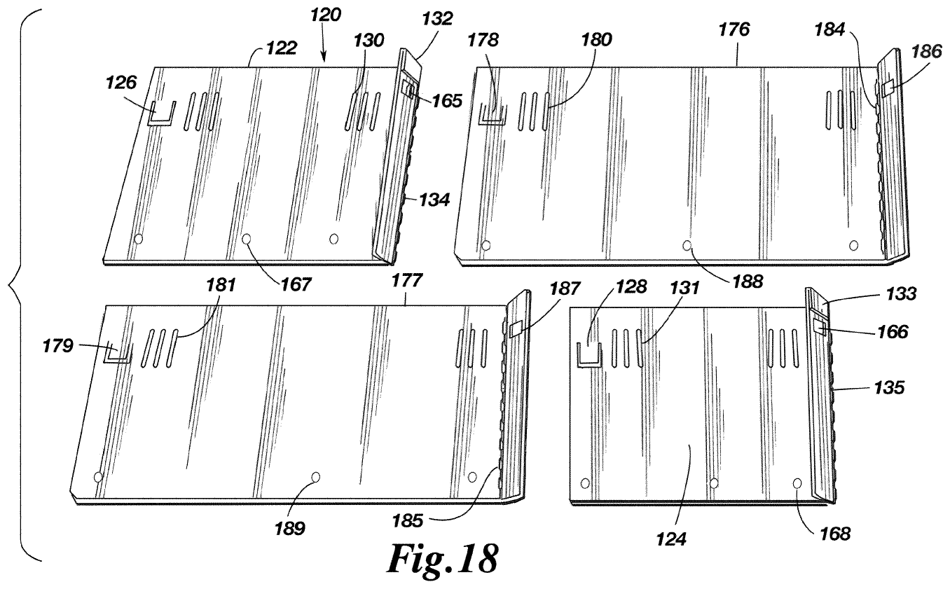

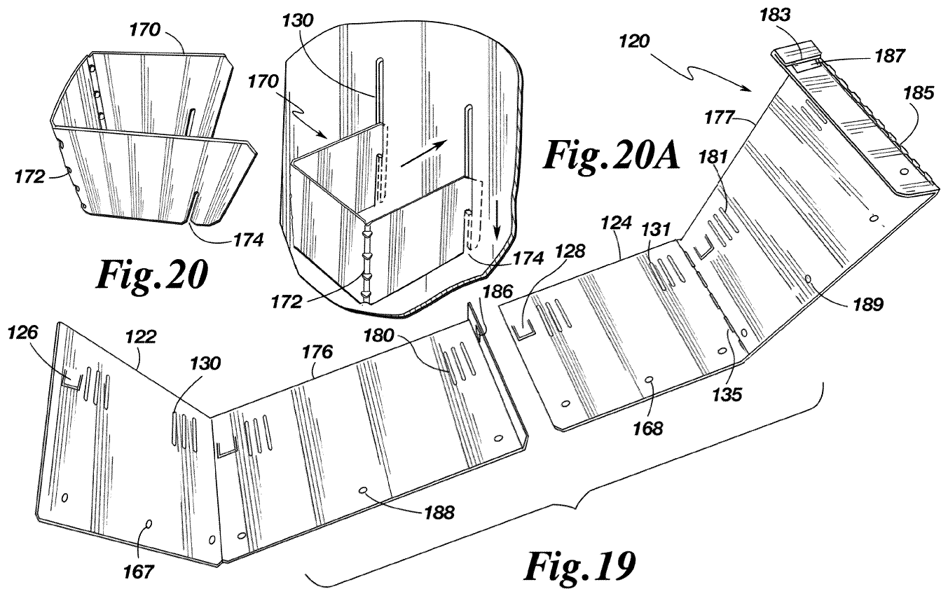

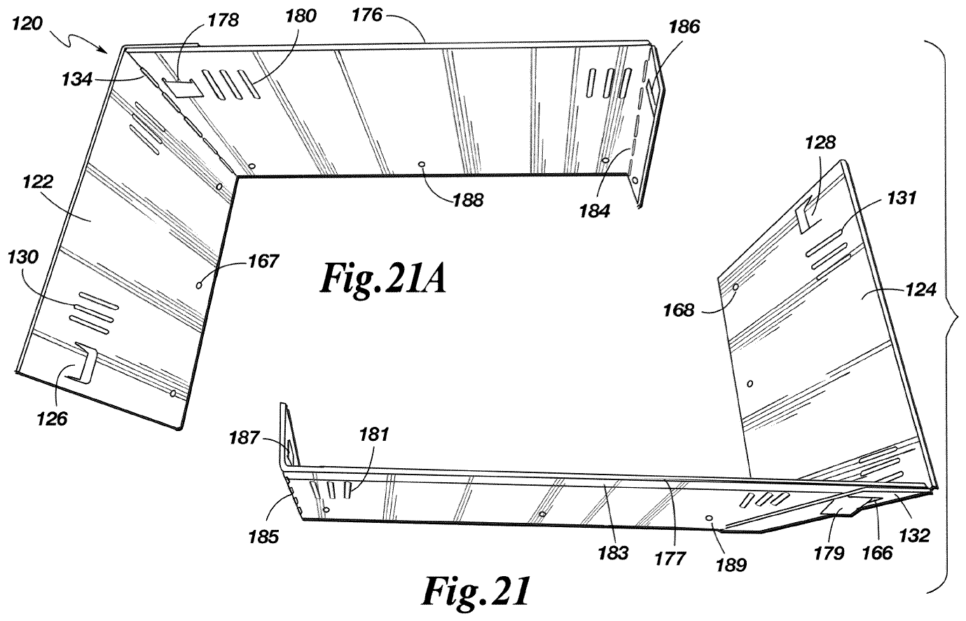

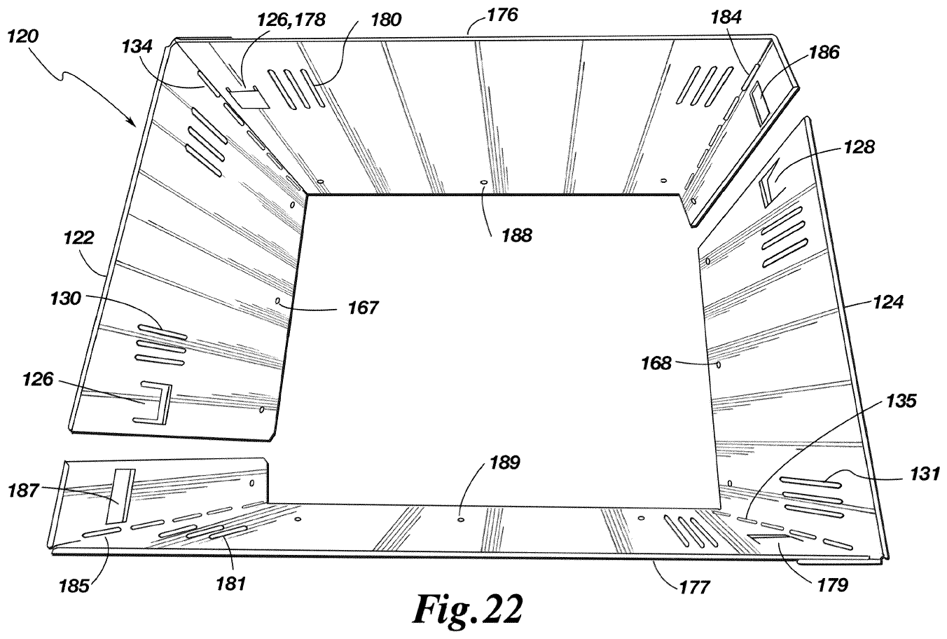

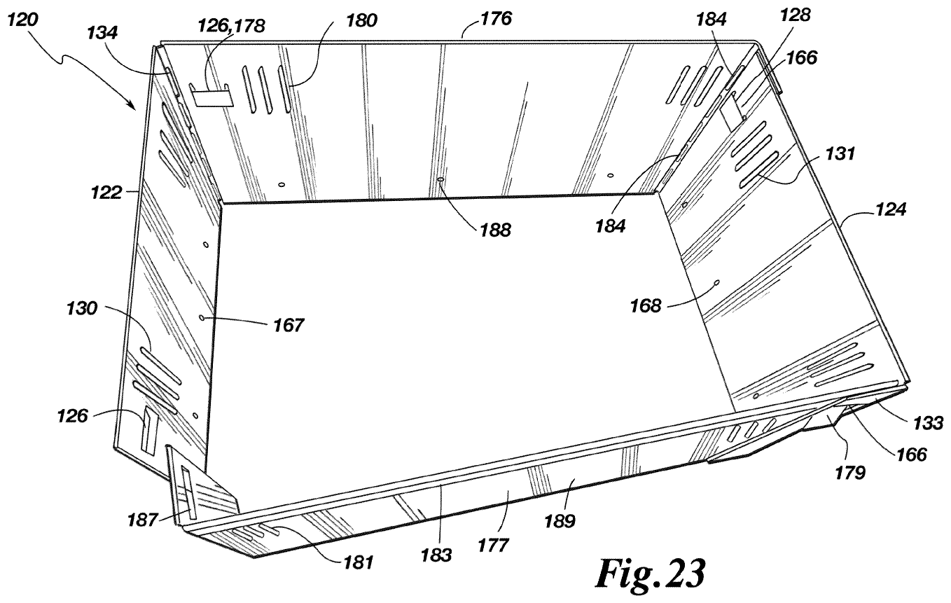

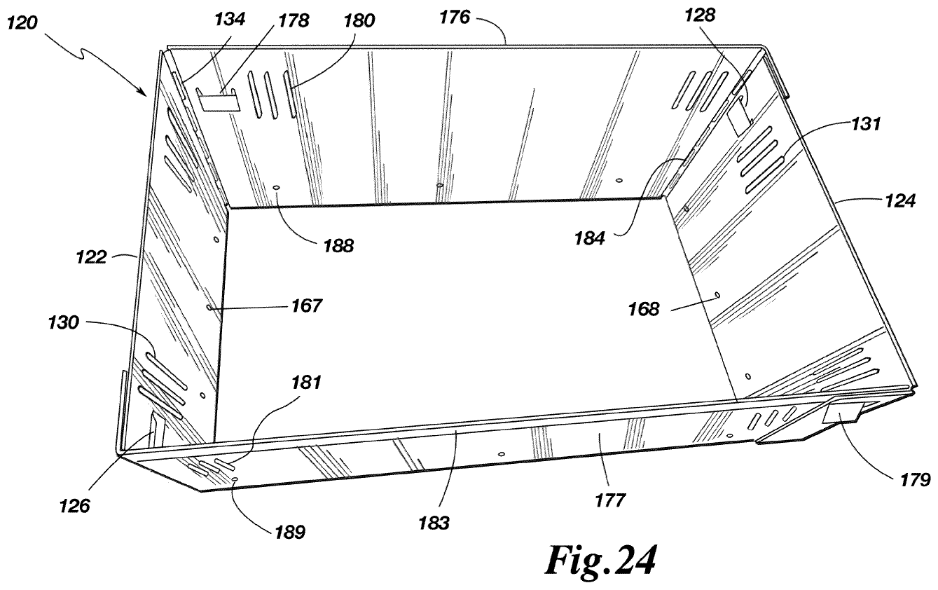

Referring to FIGS. 17 through 24 the assembly, mounting and functionality or the insulation dam 120 may be seen and understood. The dam is made of G90 galvanized steel that is 24 gauge. As shown in FIG. 17, the dam 120 and hold open key 170 are stored and shipped in flat condition including its principal components of end panels 122, 124, door hold open key 170 and side panels 176, 177.

Each end panel 122, 124 is the same. They are process utilizing a turret punch that allows for rapid and precise punching or cutting of the metal creating various features. The end panels each include corner tabs 126, 128 and key slots 130, 131. The top edges of the end panels 122, 124 include a top folded outward hems 132, 133 for strength and safety (no cutting of body parts). This step is performed by a folding machine. Also included are folding perforations 134, 135, corner slots 165, 166 and wood frame mounting holes 167, 168 to secure the panel in place with screws 190.

The door hold open key 170 comprising folding perforations 172 and mounting slots 174, 175. To assemble the key 170 is folded inwardly to form a U-shape as to form opposing key mount slots 174, 175.

Side panels 176, 177 are the same, include corner tabs 178, 179, key slots 180, 181, top folded over edges or a hem 182, 183, folding perforations 184, 185, corner slots 186, 187, wood frame mounting holes 188, 189. The top edges of the side panels 176, 177 include a top folded outward hems 183. Screws 190 are used to secure the panels in place. Also included are folding perforations 184, 185, corner slots 186, 187 and wood frame mounting holes 188, 189 to secure the panel in place with screws 190.

The end panels 122, 124 and side panels 176, 177 assemble to form the bottomless insulation dam 120, that is easily appreciated and easily performed in the attic space. Alternatively, to assemble below the attic, the last set of a tab and slot can take place above the framing in the attic.

First, all folding perforations 134, 135, 184, 185 are folded inwardly or upwardly as shown. Next, two of end and side panels 122 and 176 are locked together by inserting tab 178 into slot 165 and tab 128 into slot 186. Similarly, the next two of the side and end panels 124 and 177 have their tab 179 inserted into slot 186 and tab 128 into slot 166. Then finally tab 126 into slot 187. The insulation dam 120 is now assembled.

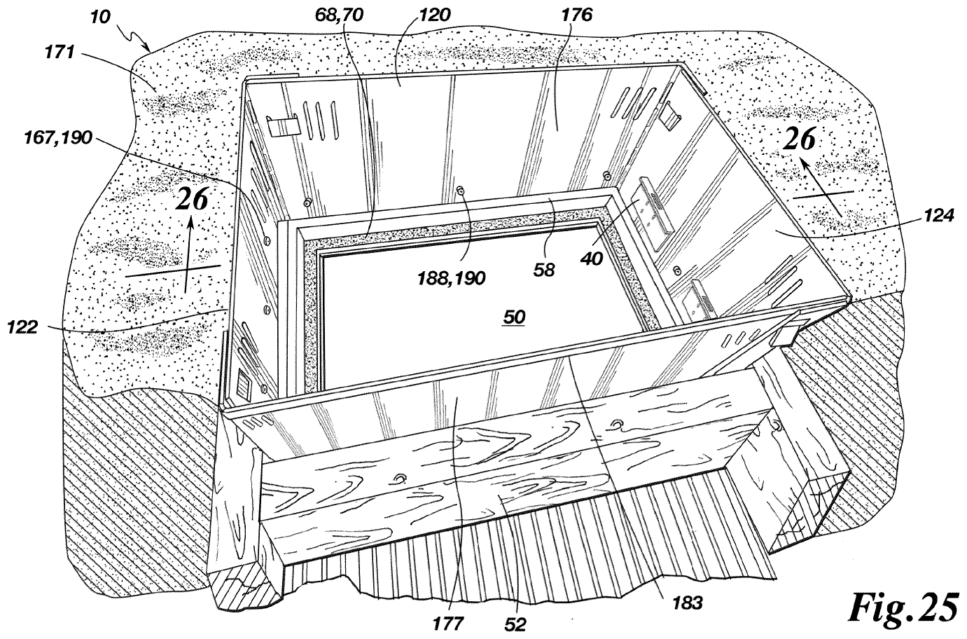

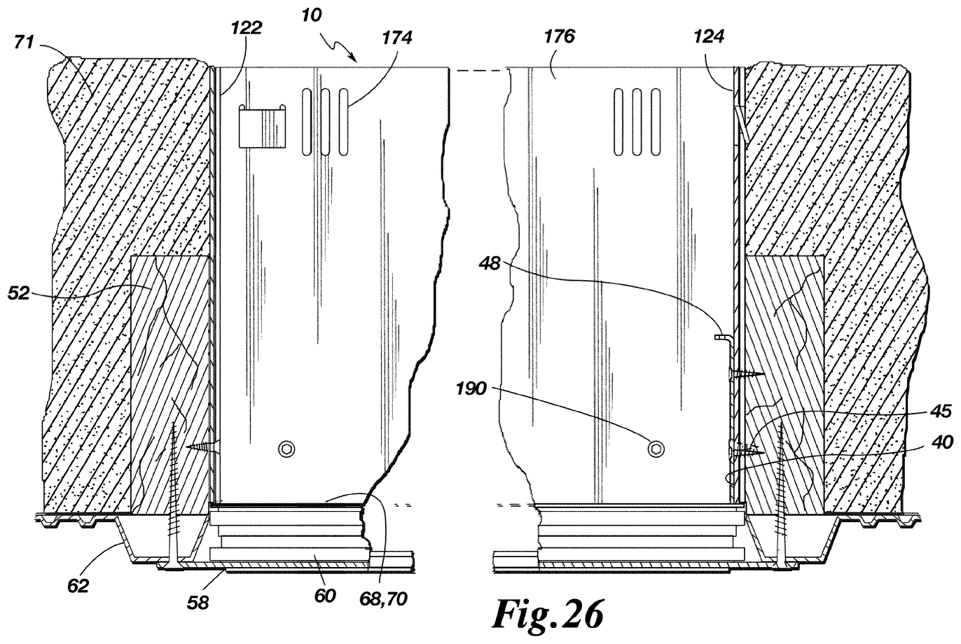

Now referring to FIGS. 25 and 26, the securement of the insulation dam 120 in place above the wood framing 52 and ceiling door frame the 58 and 60 may be understood. The insulation dam 120 is seated on the ceiling access door frame 58. Simply next, take screws 190 and screw into the wood frame 52 through holes 167, 168, 188, and 189. Blowing insulation 71 into the attic space may be completed to the height level desired on the outside of the insulation dam 120. Then, as previously explained, the ceiling access door may be installed with flat tongue 28 and slot 48 being joined and locked into place.

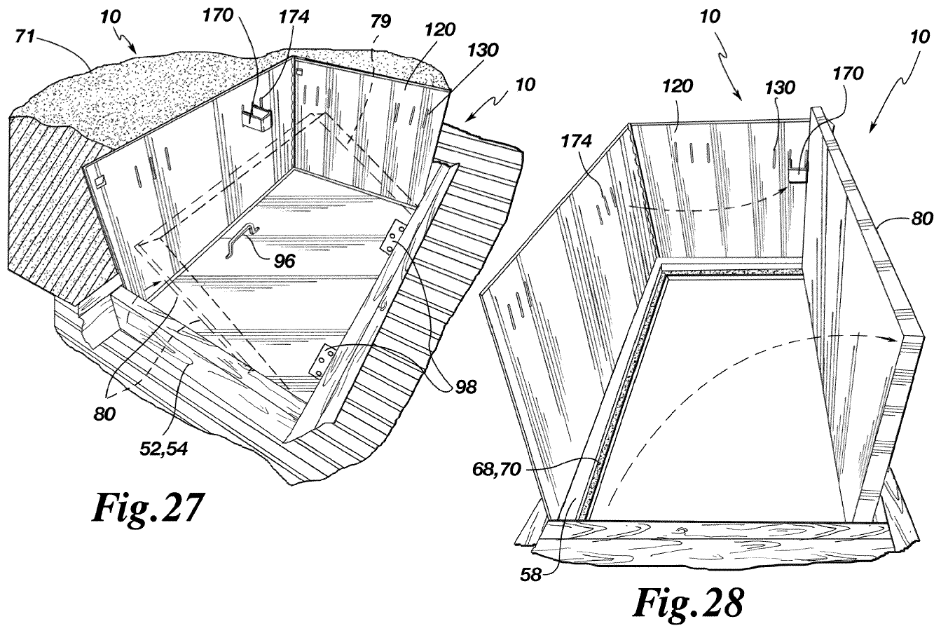

In FIGS. 27 and 28 the operation of the ceiling access doors 80, 88, 89, 90 or 91 with the side hinge 98 and insulation dam 120, partially removed, may be appreciated and understood. Door 80 illustrates a 1-inch door 80 in closed position. In phantom, partially opened door 80 has an insulation batt of fiberglass 79 when it is closed in an effort to mitigate cold and hot air from being exposed to the door 80 itself. In FIG. 27 door hold access key 170 is in its out-of-the-way storage position in slots. Insulation 71 is blocked by insulation dam 120 and cannot fall downwardly In FIG. 28 the door 80 is fully opened and secured in place by door hold access key 170.

The above descriptions and accompanying FIGS. Are for illustrative purposes. The follow claims define the meet, bounds and true scope of the present invention.

What is claimed:

1. A ceiling access door with hinges and an insulation dam for a ceiling access opening with a wood frame therearound and a ceiling access door frame therebelow, comprising:
a. a hollow ceiling access door that is injected and filled with liquid expanding curable foam;
b. a two-part tongue and slot hinge connected to the ceiling access door and the wood frame; and
c. a four-walled ceiling access insulation dam for resting on the ceiling access door frame and secured to the wood frame.

2. The ceiling access door of with hinges and an insulation dam for a ceiling access opening with a wood frame therearound and a ceiling access door frame therebelow of claim 1, wherein the ceiling access door is two metal pans adhesively secured together.

3. The ceiling access door with hinges and an insulation dam for a ceiling access opening with a wood frame therearound and a ceiling access door frame therebelow of claim 1, wherein the ceiling access door is made of two panels joined together by a continuous piano hinge that allows the two panels to fold together in flush engagement.

4. The ceiling access door with hinges and an insulation dam for a ceiling access opening with a wood frame therearound and a ceiling access door frame therebelow of claim 1, wherein the foam comprises two part polyurethane.

5. The ceiling access door with hinges and an insulation dam for a ceiling access opening with a wood frame therearound and a ceiling access door frame therebelow of claim 1, wherein the two part tongue and slot hinge comprises a flat tongue with a mounting plate to be attached to the door and a second mounting to be attached to the wood frame having a tongue slot.

6. The ceiling access door with hinges and an insulation dam for a ceiling access opening with a wood frame therearound and a ceiling access door frame therebelow of claim 1, wherein the tongue and slot fit loosely together.

7. The ceiling access door with hinges and an insulation dam for a ceiling access opening with a wood frame therearound and a ceiling access door frame therebelow of claim 1, wherein the insulation dam comprises two metal end walls and two metal side walls that interconnect together by way of extending tabs that interlock with slots.

8. The ceiling access door with hinges and an insulation dam for a ceiling access opening with a wood frame therearound and a ceiling access door frame therebelow of claim 1, wherein the end and side panels are made of galvanized steel.

9. A ceiling access door with hinges and an insulation dam for a ceiling access opening with a wood frame therearound and a ceiling access door frame therebelow, comprising:
a. a hollow ceiling access door made of two opposing rimmed pans adhesively secured together that is injected and filled with liquid expanding curable polyurethane foam;
b. a two-part tongue and slot hinge comprises a flat tongue with a mounting plate connected to the ceiling access door and a second mounting plate to be attached to the wood frame have a tongue slot, the hinge fitting loosely together; and
c. a four-walled ceiling access insulation dam comprising two metal end walls and two metal side walls that interconnect together by way of extending tabs that interlock with slots, the dam for resting on the ceiling access door frame, secured to the wood frame and adapted to hold back blown insulation.

10. A two-part tongue and slot hinge, comprising:
a. a flat vertical metal tongue with a with a 90° horizontal first mounting plate adapted to be positioned and mounted to an edge of a horizontally positioned door to be pivoted upwardly or downwardly; and
b. a second metal mounting plate adapted to be positioned and mounted vertically on a frame having a short wall 90° horizontally from the second mounting plate having a slot therein wherein the tongue is adapted to rest in the slot in a loose arrangement.

11. The two-part tongue and slot hinge of claim 10, wherein between the tongue and the first mounting plate are perforations to assist in folding from flat to normal relationship between the tongue and the first mounting plate.

12. The two-part tongue and slot hinge of claim 10, wherein at a distal end of the tongue from the first mounting plate are perforations forming tabs that may be folded in opposite directions once the tongue is inserted into the channel to lock the tongue in the slot.

13. A four-walled ceiling access insulation dam for an attic ceiling access opening, comprising two metal end walls and two metal side walls that interconnect together by way of extending tabs that interlock with slots creating a rectangular shape, the dam for resting on a ceiling access door frame and secured to a wood frame.

14. A bifold ceiling access door for a ceiling access opening with a wood frame therearound and a ceiling access door frame therebelow, comprising:
a. a hollow ceiling access door in excess of 2 inches thick made of two door panels each being injected and filled with liquid expanding curable foam and are adapted to rest on the ceiling access door frame; and
b. a continuous piano hinge joining the two panels at their adjacent bottom edges so that the panels fold upwardly and abut each other to solve a geometric problem of door interference with the wood door frame without sacrificing insulated door thickness and provide easy open and closing of the doors.

15. The bifold ceiling access door with mounting hinges of claim 14, further comprising thermal and draft insulation stripping adhered to a one leaf side of the hinge.

16. The bifold ceiling access door with mounting hinges of claim 14, further comprising a top side pivoting two piece strut for stabilizing, guiding and holding the access door and provides that once the strut passes over 180°, the strut locks in place and will hold open the bifold doors.

17. The bifold ceiling access door with mounting hinges of claim 14, further comprising a handle that provides assistance in opening and closing the door from the attic space.
